(19) United States
(12) Patent Application Publication
(10) Pub. No.: US 2026/0094349 A1
(43) Pub. Date: Apr. 2, 2026

(54) METHOD FOR MODELING 2D AND 3D SCENES BY PERFORMING GAUSSIAN SPLATTING USING VARIATIONAL BAYES

(71) Applicant: Verses AI, Inc., Vancouver (CA)

(72) Inventors: Toon Van de Maele, Ghent (BE); Ozan Catal, Ghent (BE); Tim Verbelen, Dendermonde (BE)

(21) Appl. No.: 19/337,170

(22) Filed: Sep. 23, 2025

Related U.S. Application Data
(60) Provisional application No. 63/701,522, filed on Sep. 30, 2024.

(51) Int. Cl. G06T 15/08; G06N 20/00

(52) U.S. Cl. CPC G06T 15/08; G06N 20/00

(57) ABSTRACT

A method for modeling 2D and 3D scenes by performing Gaussian splatting using variational Bayes to provide the benefit of continual learning from sequentially streamed data from multidimensional scenes.

### FIELD OF THE INVENTION

The invention deals with artificial intelligence software in agent-based systems.

### BACKGROUND

3D Gaussian Splatting is an approach for modeling 2D and 3D scenes using mixtures of Gaussians. Software in prior arts relies on backpropagating gradients through a differentiable rendering pipeline. Such an approach struggles with issues of sudden forgetting of previously learned information when retrained with continuous streams of data for novel tasks (a.k.a. Catastrophic Forgetting). (Robert M French. Catastrophic forgetting in connectionist networks. Trends in cognitive sciences, 3 (4):128-135, 1999). To mitigate this issue, prior art softwares use replay buffers to retain and retrain on older data (Hidenobu Matsuki, Riku Murai, Paul H. J. Kelly, and Andrew J. Davison. Gaussian splatting slam, 2024). However, this is computationally expensive and memory intensive.

### SUMMARY OF THE INVENTION

According to the present invention, there is provided a method for modeling a multidimensional scene (object) performing Gaussian Splatting using Variational Bayes, known as Variational Bayes Gaussian Splatting (VBGS), achieving improvement in the processes of representations of multidimensional (2D and 3D) scenes over standard softwares in the industry. The improvement provides the benefit of continual learning from sequentially streamed data from multidimensional scenes. The present invention leverages the conjugacy properties of multivariate Gaussians and creates a closed-form variational update rule that allows efficient updates from partial, sequential observations without the need for replay buffers. This involves training a Gaussian splat as is known in the arts (Bernhard Kerbl, Georgios Kopanas, Thomas Leimkühler, and George Drettakis. 3d gaussian splatting for real-time radiance field rendering ACM Transactions on Graphics, 42(4), July 2023) as variational inference over model parameters. In one embodiment of this invention, the code for the method for performing VBGS is implemented using the Python programming language and is composed of a modelling method whereby one defines a generative model over variables of a distribution that define the data points and colors of an image (e.g., the photo of a drink can), an infer method whereby the posterior of the distributions forming the generative model are inferred to generate a multidimensional—2D or 3D—scene of the object represented in the image, and an update method whereby the generative model used to infer the multidimensional scene is updated to allow for continual learning.

### BRIEF DESCRIPTION OF THE DRAWINGS

FIG. 1 presents a flowchart of the invention

### DETAILED DESCRIPTION

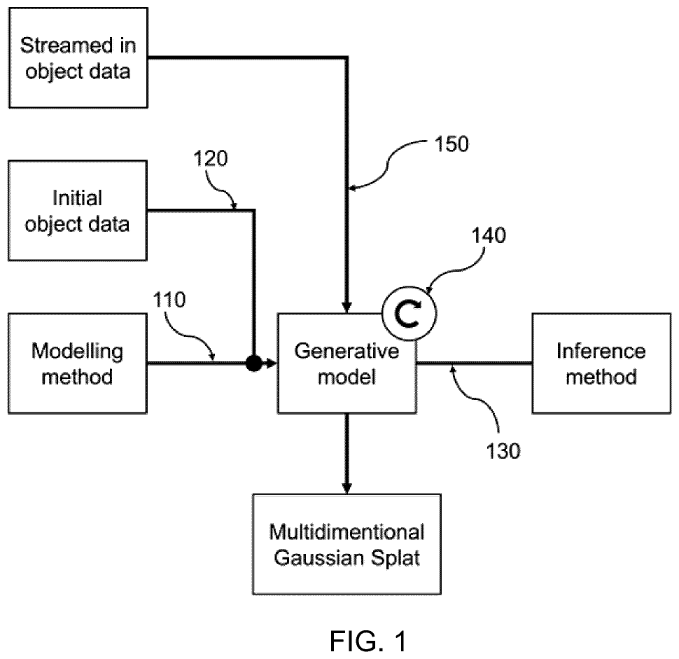

FIG. 1 depicts a flowchart of the invention for defining a multidimensional object. Using a computer program, a modelling method 110 is used to define the functional form of one or more distributions of interest out of the exponential family (e.g., normal, exponential, gamma, chi-squared, beta, Dirichlet, Bernoulli, categorical, etc.), and describing a particular generative model (discussed further below) for representing one or more data modalities such as space or color. In one example, which is discussed here, the invention is described with respect to space and color modalities associated with the multidimensional object. In this example, we model the distribution over all data modalities (in this case color and space). The generative model of the present invention makes use of a special kind of Gaussian mixture model, such as known in the arts (Reynolds, D. (2009). Gaussian Mixture Models. In: Li, S. Z., Jain, A. (eds) Encyclopedia of Biometrics. Springer, Boston, MA.), with K mixture components. The present invention, however, uses a mixture model, which is defined herein as a Gaussian mixture model, where each of the modalities has a conditionally independent likelihood, given a mixture component, that is parameterized by a multivariate normal distribution, with a Normal-Inverse-Wishart prior over its parameters. The resultant mixture model that makes use of said mixture component has a Categorical distribution over a mixture weight, with a Dirichlet prior, such as known in the arts. In the present invention, the generative model is a mixture model with K components, each characterized by two conditionally independent modalities, which, in this example, are the spatial position “s” and color “c” of the data points of the image 120, wherein “s” represents the row and column coordinates of pixel locations in the case of a 2D image, and wherein “s” represents cartesian coordinates of pixel locations in the case of a 3D image, and wherein the modality “c” represents the Red Green Blue (RGB) values of the object's colors. For each K component, the spatial positions “s” and color “c” are modelled as a multivariate normal distribution, parameterized by a mean (mu_{s,k}) and covariance (Sigma_{s,k}) for the multivariate normal distribution over “s”. For the multivariate normal distribution over “c”, the parameters are (mu_{c,k}), and (Sigma_{c,k}) respectively. Each mixture component also has an associated variable “z”, indicating the particular cluster of the mixture model. The generative model can be represented as the joint distribution:

$$\begin{matrix}p ( s , c , z , {μ}_{s} , {\sum }_{s} , {μ}_{c} , {\sum }_{c} , π ) = ( {\prod }_{n = 1}^{N} p ( {s}_{n} \vert {z}_{n} , {μ}_{s} , {\sum }_{s} ) p ( {c}_{n} \vert {z}_{n} , {μ}_{c} , {\sum }_{c} ) p ( {z}_{n} \vert π ) ) \\ ( {\prod }_{k = 1}^{K} p ( {μ}_{k , s} , {\sum }_{k , s} ) p ( {μ}_{k , c} , {\sum }_{k , c} ) ) p ( π ) .\end{matrix}$$

Wherein this equation specifies the joint distribution. The left hand side of the first line specifies the likelihoods over the data (space s and color c), and the mixture weight z. While the second line specifies the prior over the model parameters. The joint distribution can be factored into the likelihood of the “s” and “c” data points p(s|z,μₛ,Σₛ) and p(c|z,μ_{c},Σ_{c}) and into a prior distribution over the mixture model parameters, a prior over the parameters of the conditional likelihood over “s”, a prior over the parameters of the conditional likelihood over “c”, and a prior over the mixture weights z. The invention makes use of an inference method 130, which uses a computer program to estimate the distribution parameterizing the random variables “s”, “c” and “z” according to the generative model by inferring their posterior distribution. This is achieved using one or more variational inference methods, such as known in the arts (Michael I. Jordan, Zoubin Ghahramani, Tommi S. Jaakkola, and Lawrence K. Saul. An Introduction to Variational Methods for Graphical Models, page 105-161. Springer Netherlands, 1998. ISBN 9789401150149. doi: 10.1007/978-94-011-5014-9_5). This involves introducing a variational posterior denoted “q” in the arts, calculating and maximizing the Evidence Lower Bound (ELBO) for the space and color data, with respect to each of the parameters' of the variational posterior known as natural parameters in the arts, using coordinate ascent variational inference (CAVI) such as known in the arts (Matthew James Beal. Variational Algorithms for Approximate Bayesian Inference. PhD thesis, University College London, 2003). The multidimensional output is generated by computing the expected value of the pixels' color “c” given the spatial coordinates “s” ( [symbol] _{p(c/s)}[c]), wherein for 3D outputs one or more renders such as known in the arts are used (Bernhard Kerbl, Georgios Kopanas, Thomas Leimkühler, and George Drettakis. 3d Gaussian splatting for real-time radiance field rendering. ACM Transactions on Graphics, 42(4), July 2023).

The invention makes use of an update method 140, which uses a computer program for continual learning to update each of the natural parameters by computing the sum of the prior parameter with the sum of the sufficient statistics of the observed data. The update method allows the claimed invention to avoid the problem of catastrophic forgetting. In the present illustration of the claimed invention, the update equations for the natural parameters n, v, and streamed in data x 150 are

$$\begin{matrix}{η}_{k} = {η}_{0 , k} + {\sum }_{{x}_{n} ∈ 𝒟} {γ}_{k , n} T ( {x}_{n} ) \\ {v}_{k} = {v}_{0 , k} + {\sum }_{{x}_{n} ∈ 𝒟} {γ}_{k , n} ,\end{matrix} ,$$

where η and v are the natural parameters of the posterior distribution over the natural parameters of the conditional likelihoods, and the prior over the mixture weights. T(xn) are the sufficient statistics of the data xn. For the approximate posterior q(μs,k, Σs,k) over the parameters of the spatial likelihood, the sufficient statistics are given by T (sn)=(sn, sn·s\hat{ }Tn). The Normal Inverse Wishart (NIW) conjugate prior consists of a Normal distribution over the mean and an inverse Wishart distribution over the covariance matrix. Hence, for each of the prior's natural parameters, it has two values: η0,s=(κ0,s·m0,s, V0,s+κ0,s·m0,s·mT0,s) and v0,s=(κ0,s, n0,s+Ds+1). Here, m0,s is the mean of the Normal distribution over the mean; κ0 is the concentration parameter over the mean; n0,s indicates the degrees of freedom; V0,s is the inverse scale matrix of the NIW distribution, and Ds the dimensionality of the multivariate Normal (MVN) distribution. Here, γ refers to the approximate posterior distribution over the mixture weight z, computed as a categorical distribution, whose parameters are proportional to the evidence lower bound as a function of the observed data and mixture weight z. The parameter update is commutative, meaning that the order of the observed data x does not impact the result as long as the approximate posterior γ is computed with respect to the same prior distribution. It is this aspect of the update method that allows for continual learning upon the receipt of streamed in data 150 without catastrophic forgetting. For continual learning, the update equations implemented by computer program are formulated in an iterative form as

$${η}_{t , k} = {η}_{i - 1 , k} + {\sum }_{{x}_{n} ∈ {𝒟}_{i} {γ}_{k , n} T ( {x}_{n} )} and {v}_{t , k} = {v}_{t - 1 , k} + {\sum }_{{x}_{n} ∈ {𝒟}_{t}} {γ}_{k , n} ,$$

where one makes the update a function of the posterior parameters at time t−1. If the statistics of the initial data is not known in advance by the generative model, the natural parameters of the prior might not accurately reflect the data, in which case this problem remains. This is so because each update is a computer using the same prior distribution—that of the generative model. To mitigate this, the claimed method uses computer code to move, or reassign, the mean of the data for the space and color modalities for which the parameters have not been updated (i.e., the value of the prior over z at the current time still equals the value of prior z before observing any data, α_{t,x}=α_{0,x}) to the mean of data points that have the lowest ELBO.

The claimed invention is:

1. A method for modeling a 2D or 3D object through improved Gaussian splatting, comprising,
implementing in a generative model natural parameters of one or more distributions that are part of a family of distributions called the Exponential family, wherein the distribution represents one or more modalities of a multidimensional object,
estimating the one or more distributions by inferring their posterior distributions, using one or more iterative methods implemented in computer program,
generating a multidimensional scene by computing the expected value of the one or more modalities,
updating the natural parameters of the distributions that are part of the Exponential family implemented in the generative model by summing the prior parameter with the sum of multiple sufficient statistics of the one or more modalities data, and
assigning a mean of the modalities to a mean of data points that have the lowest Evidence Lower Bound (ELBO), for the modalities not yet represented in the prior or the generative model.

2. A method of claim 1, wherein the one or more iterative methods includes a variational inference method, wherein a variational posterior, denoted “q”, is introduced to calculate and maximize the Evidence Lower Bound (ELBO) for the one or more modalities' data.

3. A method of claim 1, wherein the computation of the expected value for the outputs of a 3D object requires one or more renders.
